(19) United States
(12) Patent Application Publication
(10) Pub. No.: US 2015/0300438 A1
(43) Pub. Date: Oct. 22, 2015

(54) DEFORMABLE ELEMENT

(71) Applicant: THE SECRETARY OF STATE FOR DEFENCE, Salisbury, Wiltshire (GB)

(72) Inventor: Ian David ELGY, SALISBURY (GB)

(21) Appl. No.: 14/646,557

(22) PCT Filed: Nov. 18, 2013
(86) PCT No.: PCT/GB2013/000489

§ 371 Date: May 21, 2015

(30) Foreign Application Priority Data
Nov. 23, 2012 (GB) 1221064.7

(51) Int. Cl. F16F 7/12; B05D 3/12; B05D 1/18; B60R 21/04

(52) U.S. Cl. CPC F16F 7/121; B60R 21/04; B05D 3/12; B05D 1/18; B60R 2021/0046

(57) ABSTRACT

A deformable element (100) comprising a deformable structure (115) and a shear thinning material (113) within the deformable structure. The deformable structure comprises one or more holes (112) through which the shear thinning material will exit the deformable structure and thereby allow deformation of the deformable element upon application of greater than a predetermined level of mechanical shock to the deformable element

### TECHNICAL FIELD OF THE INVENTION

The invention relates to a deformable element. The deformable element may be suitable for use in a shock absorbing panel.

### BACKGROUND TO THE INVENTION

Deformable elements are useful in situations where deformation of the element is required when forces exceed a given level, for example in providing protection from impacts.

Deformable elements find applications in safety padding, for example in order to protect persons from high levels of mechanical shock (high acceleration/de-acceleration) which could otherwise cause injury. One such application of deformable elements is in vehicle footpads, which may be designed to avoid transmitting mechanical shock from a structural deformation of the vehicle through to a person's foot. The structural deformation may for example be due to an explosion beneath the vehicle. Deformable elements are also useful to protect vehicle occupants from rapid acceleration/de-acceleration of armoured surfaces during attacks.

Known vehicle footpads commonly comprise foam padding deformable element(s), although these become more and more compressed by feet resting upon them during the normal use of the vehicle, and over time lose their ability to prevent transmission of shock between the base armour of a vehicle and a person's foot.

Some types of deformable element are designed to be rigid unless there is sufficient force to shatter or deform them, although such known deformable elements often allow transmission of too much shock before the shattering/deforming takes place.

U.S. Pat. No. 6,029,962 discloses a shock absorbing component constructed from a thermoplastic material having two opposing surfaces with meshed hemispheres extending to meet one another therebetween. The meshed hemispheres are support members that flex to allow the two opposing surfaces to move towards one another whilst dampening shock.

However, shock may still pass through the shock absorbing component before significant flexing of the meshed hemispheres takes place, and the meshed hemispheres may repeatedly flex during normal use causing them to degrade and/or sag over time.

It is therefore an aim of the invention to provide an improved deformable element.

### SUMMARY OF THE INVENTION

According to a first aspect of the invention, there is provided a deformable element comprising a deformable structure and a shear thinning material within the deformable structure, the deformable structure comprising one or more holes through which the shear thinning material will exit the deformable structure and thereby allow deformation of the deformable element upon application of greater than a predetermined level of mechanical shock to the deformable element.

Shear thinning materials are known to be much less viscous when subjected to higher rates of shear than when subjected to, lower rates of shear, and so the incorporation of such a material into a deformable structure having holes means that:
under lower mechanical shocks, causing lower rates of shear within the shear thinning material, the shear thinning material is too viscous to flow out of the holes and so helps maintain the shape of the deformable element; and
under higher mechanical shocks, causing higher rates of shear within the shear thinning material, the shear thinning material is less viscous and moves out of the holes to allow the deformable element to deform.

The type of shear thinning material and the number and sizes of the holes are chosen to set the predetermined level of mechanical shock. Clearly, the larger the holes, the more easily the shear thinning material will be able to exit the deformable structure and allow the deformable element to deform. One commonly known shear thinning material which may be used is bentonite, although other shear thinning materials also exist as will be apparent to those skilled in the art, for example thixotropic oils and lubricants.

The shear thinning material may be filled within a cavity of the deformable structure, and the shear thinning material may exit the cavity through the one or more holes to allow deformation of the deformable element when the greater than the predetermined level of mechanical shock is applied to the deformable element.

Advantageously, each deformable structure may comprise walls that contain the shear thinning material within the deformable structure, and the one or more holes may extend through the walls from an inside of the deformable structure, for example from a cavity of the deformable structure, to an outside of the deformable structure. Accordingly, upon mechanical shock the shear thinning material may move through the holes to exit the deformable structure so that the deformable element can deform.

The deformable element may be capable of bearing loads without any significant deformation of the deformable element. For example, when the deformable element is loaded the shear thinning material may press against walls of the deformable structure to maintain the shape of the deformable structure.

Advantageously, the load bearing capability of the deformable element may derive from the shear thinning material maintaining the shape of the deformable structure, rather than from the structural strength of the deformable structure itself. Accordingly, when the shear thinning material leaves the deformable structure as a result of moving out through the holes under high shock, the deformable element easily deforms and so transmits minimal shock across it.

The deformable structure may be an open-celled foam, the open-celled foam being filled with the shear thinning material. Then, the deformable element may be easily constructed by using vibrations to fill the open-celled foam with the shear thinning material. The open-celled foam may comprise channels that are least two cell widths wide to assist movement of the shear thinning material through the foam. The channels may run through the foam in a similar direction in which the deformable element is likely to be deformed, for example perpendicular between two layers at either side of the deformable element. Then the fluid is forced through the open cells rather than along the channels during deformation. This raises the predetermined level of mechanical shock, since it is harder for the shear thinning material to move through the narrower cells than through the wider channels.

The cell density of the open-celled foam may be set according to the predetermined level of mechanical shock. For example higher cell densities will typically have smaller holes, and therefore the predetermined level will be higher.

The deformable elements are intended to prevent transmission of higher shock through the deformable elements, whilst still providing rigidity under lower shocks. The actual energy that is absorbed by the deformable elements during deformation may be minimal to help assure that high shock forces are not transmitted through the deformable elements.

According to a second aspect of the invention, there is provided a shock absorbing panel comprising a first layer, a second layer, and at least one of the deformable elements according to the first aspect of the invention therebetween. The deformable elements between the first and second layers may deform to reduce transmission of high shocks between the first and second layers.

Preferably, the first and second layers are spaced apart from one another by the at least one of the deformable elements, so that the forces on the first and second layers are directly coupled to the deformable elements. The first and second layers may be substantially planar, and may also be parallel to one another.

The at least one of the deformable elements may be a plurality of the deformable elements. Furthermore, the plurality of the deformable elements may be spaced apart from one another, with the holes of the deformable structures being directed towards spaces between the deformable elements. Then the shear thinning material is able to move into the spaces between the deformable elements during high shocks, allowing the deformable elements to easily deform.

Each one of the deformable elements may be a column that extends between the first and second layers perpendicular to the first and second layers. The holes may be spaced around the column so that the shear thinning material can exit the columns under high shocks.

Preferably, each column extends all of the way between the first and second layers, although use of an intermediate layer with columns between the first layer and the intermediate layer, and between the intermediate layer and the second layer, may also be possible. A column is considered to be a three dimensional shape that is longer than in a direction between the first and second layers than in a direction parallel to the first and second layers, without restriction as to cross-sectional shape.

Advantageously, the shock absorbing panel may be implemented as a footpad for a vehicle, for example to protect the vehicle occupant's feet from structural deformation of the base of the vehicle during explosions beneath the vehicle.

According to a third aspect of the invention, there is provided a method of making a deformable element configured to deform upon application of greater than a predetermined level of mechanical shock, the method comprising placing a deformable structure into a bath of shear thinning material, and vibrating the shear thinning material to fill the deformable structure with the shear thinning material.

The deformable structure may for example be an open-celled foam or a wire mesh structure.

### BRIEF DESCRIPTION OF THE DRAWINGS

Embodiments of the invention will now be described by way of example only and with reference to the accompanying drawings, in which:

FIG. 1a shows a schematic perspective diagram of a panel having deformable elements according to a first embodiment of the invention;

FIG. 1b shows a cross-sectional diagram of one of the deformable elements of FIG. 1a; and

FIG. 2 shows a schematic perspective diagram of a panel having a deformable element according to a second embodiment of the invention.

The drawings are for illustrative purposes only and are not to scale.

### DETAILED DESCRIPTION

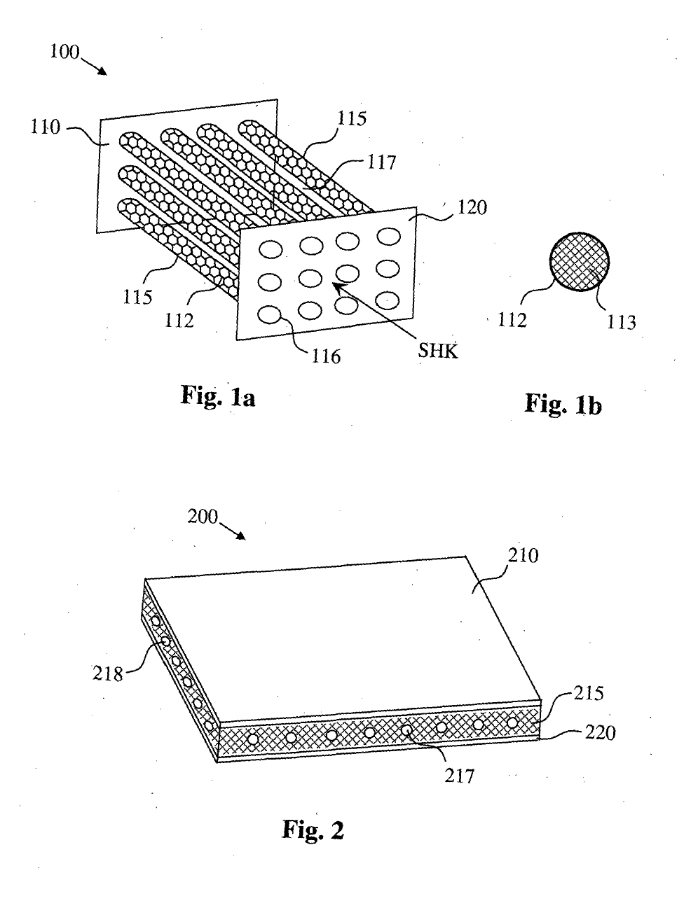

A first embodiment of the invention will now be described with reference to the schematic Diagrams of FIGS. 1a and 1b. The perspective diagram of FIG. 1a shows twelve deformable elements in the form of twelve columns 115. The twelve columns 115 are connected to two aluminium sheets 110 and 120, perpendicular between the two aluminium sheets.

Each column 115 has a cylindrical shape, as illustrated by end 116, and is formed from a wire mesh 112. Specifically, the wire mesh 112 forms an exterior wall of the column 115, and has many holes passing through it due to the mesh pattern, the holes going from the inside to the outside of the column 115. The holes are directed towards the spaces in between the columns 115.

The inside of each column 115 is filled with a core of shear thinning material 113, in this example bentonite. For example, refer to FIG. 1b which shows a cross sectional view through one of the columns 115. The wire mesh 112 can be seen encircling the core of shear thinning material 113. In other words, the core of shear thinning material 113 is held within a cavity defined by the wire mesh 112.

The two aluminium sheets 110 and 120, and the twelve columns 115, together form a shock absorbing panel 100. Under normal conditions where the panel 100 is not subjected to high mechanical shock, the shear thinning material 113 is too viscous to flow through the holes in the wire mesh 112, and remains inside the columns 115. The wire mesh 112 is a deformable structure, which by itself does not have much structural rigidity, although the panel 100 can still support significant weight since the shear thinning material 113 prevents deformation of the wire mesh 112, in much the same way as a drinks can cannot be compressed whilst it is still full of drink.

Upon application of greater than a predetermined level of mechanical shock SHK to the aluminium sheet 120, the viscosity of the betonite drops to a level where it can quickly flow out of the holes in the wire mesh 112, and into the spaces 117 between the deformable elements 115. The movement of the bentonite out of the columns 115 removes the support that was previously provided by the betonite, allowing the columns 115 to deform and the aluminium sheet 120 to move towards the aluminium sheet 110 under the force of the mechanical shock SHK.

The deformation of the columns 115 prevents significant transmission of the mechanical shock SHK through the panel, protecting any delicate entities that are in contact with the aluminium sheet 110.

The panel 100 may for example be used as a footpad for a vehicle, the aluminium sheet 110 for supporting a person's foot and the aluminium sheet 120 resting on the base armour of the vehicle. The number, length, and cross-sectional area of the columns may be modified according to how the panel 100 is required to respond to mechanical shocks.

For a vehicle footpad application, in one example, the panel 100 may be set to crush under a strain rate of 10² s⁻¹, but to remain solid at a strain rate of 10¹ s⁻¹. The panel may begin to soften and crush if the velocity of the aluminium sheet 120 towards the aluminium sheet 110 plate exceeds 10 ms⁻¹.

A second embodiment of the invention will now be described with reference to the schematic perspective diagram of FIG. 2, which shows a shock absorbing panel 200 having a deformable element 215 sandwiched between two plastic plates 210 and 220.

The deformable element 215 is an open-celled foam, which has been saturated with shear thinning material, for example by soaking the open-celled foam in a bath of bentonite which is vibrated with sufficient force for the bentonite to flow into the open cells. The bath itself may be vibrated, or a mechanical agitator such as a vibrating paddle may be placed within the bath to agitate the bentonite to a point where it sufficiently reduces in viscosity to flow into the open cells. The same technique may be used to fill the wire mesh columns of the first embodiment of the invention, or the cylindrical cores 113 may be cut from bentonite, and inserted into the cylindrical wire mesh deformable structures 112.

The deformable element 215 is then sandwiched between the plastic plates 210 and 220 to form the shock absorbing panel 200.

The open-celled foam may for example be formed of copper, aluminium, or polyurethane. The cell density of the open-celled foam is set according to the predetermined level of mechanical shock. A higher cell density means that the shear thinning material must reach a lower viscosity before it will flow through the cells, requiring a higher level of mechanical shock. The open-celled foam by itself is a deformable structure which does not have much structural rigidity, although which can support significant weight when filled with shear thinning material such as bentonite to form the deformable element 215.

In the FIG. 2 embodiment, the open-celled foam comprises multiple channels 217 and 218 running through the foam, parallel to the plane of the shock absorbing panel 200. The multiple channels assist in the movement of the shear thinning material through and into or out of the open-celled foam. For example, the multiple channels may be cut out of the open-celled foam after the open-celled foam has been filled with bentonite, such that the channels are substantially clear of bentonite and provide space for the bentonite to move into upon application of greater than the predetermined amount of mechanical shock to the shock absorbing panel 200.

Alternatively, the multiple channels may be formed in the open-celled foam before the open-celled foam has been filled with bentonite, such that the channels assist infilling the open-celled foam with bentonite. Then, upon application of greater than the predetermined amount of mechanical shock to the shock absorbing panel 200, the betonite may exit the shock absorbing panel through the open ends of the multiple channels 217, 218.

The multiple channels 217 and 218 are approximately two cell widths wide, although could be made much wider if desired for easy exiting of the bentonite from the open-celled foam.

The open-celled foam may comprise additional channels (not visible in Figs) within the foam that run perpendicular to the plastic panels 210, 220, for example directly from the panel 210 to the panel 220 through the open-celled foam. The additional channels provide additional space for the shear thinning material to move within the panel, and in this particular embodiment are of the same widths as the multiple channels 217 and 218, although this is not essential. There is benefit to making the additional channels wider than the multiple channels 217, 218, so that the additional channels act as miniature reservoirs into which the bentonite can escape from the multiple channels upon application of greater than the predetermined amount of mechanical shock to the shock absorbing panel 200.

Alternatively, only the multiple channels may be present in the open-celled foam, or only the additional channels may be present in the open-celled foam. If only the additional channels are present, then the bentonite may be forced to move through the open-celled foam rather than through wider channels, since the additional channels are aligned in the same direction in which the mechanical shock is applied.

Further embodiments falling within the scope of the appended claims will also be apparent to those skilled in the art. For example, the deformable element may be formed from deformable structures other than wire mesh columns or open-celled foams, provided that the deformable structure in isolation is easily deformable, and that it is capable of being filled with a shear thinning material to provide structural strength, the shear thinning material capable of exiting the deformable structure upon high shear rates occurring as a result of greater than a predetermined level of mechanical shock.

Furthermore, the deformable element can equally be implemented in other defence or non-defence applications in which protection against excessive levels of mechanical shock is required. For example other vehicle related applications such as seat pads, collapsible steering columns and dashboards as well as industrial applications such as shock absorbing floors or surfaces.

1. A deformable element comprising a deformable structure and a shear thinning material within the deformable structure, the deformable structure comprising one or more holes through which the shear thinning material will exit the deformable structure and thereby allow deformation of the deformable element upon application of greater than a predetermined level of mechanical shock to the deformable element.

2. The deformable element of claim 1, wherein each deformable structure comprises walls that contain the shear thinning material within the deformable structure, and wherein the one or more holes extend through the walls from an inside of the deformable structure to an outside of the deformable structure.

3. The deformable element of claim 1, wherein a load bearing capability of the deformable element, upon application of less than the predetermined level of mechanical shock to the deformable element, derives from the shear thinning material maintaining the shape of the deformable structure.

4. The deformable element of claim 1, wherein the deformable structure is an open-celled foam, the open-celled foam being filled with the shear thinning material, the cell density of the open-celled foam being set according to the predetermined level of mechanical shock.

5. The deformable element of claim 4, wherein the open-celled foam comprises channels that are at least two cell widths wide.

6. A shock absorbing panel comprising a first layer, a second layer, and at least one of the deformable elements of claim 1.

7. The shock absorbing panel of claim 6 wherein the first layer and second layer are spaced apart from one another by the at least one of the deformable elements.

8. The shock absorbing panel of claim 6, wherein the at least one of the deformable elements is a plurality of the deformable elements, and wherein the plurality of the deformable elements are spaced apart from one another, the holes of the deformable structures being directed towards spaces between the deformable elements.

9. The shock absorbing panel of claim 6, wherein each one of the deformable elements is a column which extends between the first and second layers perpendicular to the first and second layers.

10. The shock absorbing panel of claim 9, wherein the column comprises a wire mesh deformable structure surrounding a core of the shear thinning material.

11. The shock absorbing panel of claim 9, wherein each column extends all of the way between the first and second layers.

12. The shock absorbing panel of claim 6, wherein the shock absorbing panel is a footpad for a vehicle.

13. A method of making a deformable element configured to deform upon application of greater than a predetermined level of mechanical shock, the method comprising placing a deformable structure into a bath of shear thinning material and vibrating the shear thinning material to fill the deformable structure with the shear thinning material.

14. The method of claim 13, wherein the deformable structure is an open-celled foam or a wire mesh structure.

15. (canceled)
